(19) United States
(12) Patent Application Publication
(10) Pub. No.: US 2008/0153539 A1
(43) Pub. Date: Jun. 26, 2008

(54) CONTROL OF ELECTROMAGNETIC FIELD PATTERNS ON A WIRELESS COMMUNICATION DEVICE

(75) Inventors: Umesh D. Navsariwala, Bartlett, IL (US); Nicholas E. Buris, Deer Park, IL (US); William H. Meitzler, Elk Grove Village, IL (US)

Correspondence Address: CUENOT & FORSYTHE, L.L.C., 12230 FOREST HILL BLVD., SUITE 120, WELLINGTON, FL, 33414, US

(73) Assignee: MOTOROLA, INC., Schaumburg, IL (US)

(21) Appl. No.: 11/616,187

(22) Filed: Dec. 26, 2006

(51) Int. Cl. H04M 1/00; H04B 1/38

(52) U.S. Cl. 455/550.1; 455/90.2

(57) ABSTRACT

A wireless communication device (100, 400) that can include a first electrically conductive structural member (102), a second electrically conductive structural member (104), and at least a first electrical conductor (118) that electrically connects a first portion (120) of the first structural member to the second structural member. A distance between the first portion and a second portion (122) of the first structural member can be selected to present a desired input impedance for an RF signal applied at the second portion of the first structural member. The distance can be approximately one-quarter of a wavelength of the RF signal or an odd multiple of the one-quarter wavelength. In another arrangement, the distance can be approximately one-half of a wavelength of the RF signal or a multiple of the one-half wavelength.

### BACKGROUND OF THE INVENTION

1. Field of the Invention

The present invention generally relates to wireless communication devices and, more particularly, to such devices that use structural components as radiating surfaces.

2. Background of the Invention

A mobile station typically communicates by establishing an RF communication link with a node of a communications network. For example, a mobile station may establish an RF communication link with a base station or a repeater of a cellular communications network. To support the RF communication link, a mobile station generally includes one or more transceivers and one or more antennas.

For a variety of reasons, mobile stations usually transmit at relatively low power. Moreover, the signal strength of received signals also is fairly low. Thus, the efficiency with which a mobile station transmits and receives RF signals is a critical factor affecting mobile station performance. Unfortunately, the efficiency is sometimes adversely affected when a mobile being is positioned next an object, such as a user's body. When a mobile station is at the fringe of a base transceiver's service area, this reduced transmit and/or receive efficiency can result in interrupted or dropped calls, which is undesirable.

### SUMMARY OF THE INVENTION

The present invention relates to a wireless communication device that can include a first electrically conductive structural member and a second electrically conductive structural member. The device also can include at least a first electrical conductor that electrically connects a first portion of the first structural member to the second structural member. In one arrangement, the first electrical conductor can be embodied as an electronic or electromechanical switch.

A distance between the first portion and a second portion of the first structural member can be selected to present a desired input impedance for an RF signal applied at the second portion of the first structural member. The distance can be approximately one-quarter of a wavelength of the RF signal or an odd multiple of the one-quarter wavelength. In another arrangement, the distance can be approximately one-half of a wavelength of the RF signal or a multiple of the one-half wavelength. Dimensions of the first electrical conductor can be selected to achieve a desired load impedance.

The wireless communication device further can include a third electrically conductive structural member. The third structural member can be a radiating member. The first structural member can be rotatably linked to the third structural member or can be statically positioned with respect to the first structural member. The wireless communication device further can include at least a second electrical conductor that provides electrical conductivity between the third structural member and the first structural member.

The present invention also relates to a method that includes selecting a desired input impedance for a transmission line formed by a first electrically conductive structural member and a second electrically conductive structural member of a wireless communication device. The method further can include electrically connecting a first portion of the first structural member to the second structural member at a selected distance from a second portion of the first structural member where an RF signal to be transmitted can be applied, the distance selected to present a desired input impedance for the RF signal.

Selecting the desired input impedance can include selecting the input impedance to have a high value. In such an arrangement, electrically connecting the first portion of the first structural member to the second structural member can include selecting the distance to be approximately one-quarter of a wavelength of the RF signal. Selecting the desired input impedance can include selecting the input impedance to have a low value. In this arrangement, electrically connecting the first portion of the first structural member to the second structural member can include selecting the distance to be approximately one-half of a wavelength of the RF signal.

The method further can include rotatably linking the third structural member to the first structural member or statically positioning the third structural member with respect to the first structural member.

### BRIEF DESCRIPTION OF THE DRAWINGS

Preferred embodiments of the present invention will be described below in more detail, with reference to the accompanying drawings, in which:

FIG. 1 depicts a wireless communication device that is useful for understanding the present invention;

FIG. 2 depicts a section view of the wireless communication device of FIG. 1, taken along section line 2-2;

FIG. 3 depicts an electrical schematic that is useful for understanding the present invention;

FIG. 4 depicts another example of the wireless communication device that is useful for understanding the present invention;

FIG. 5 depicts a section view of the wireless communication device of FIG. 4, taken along section line 5-5; and

FIG. 6 is a flow chart that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

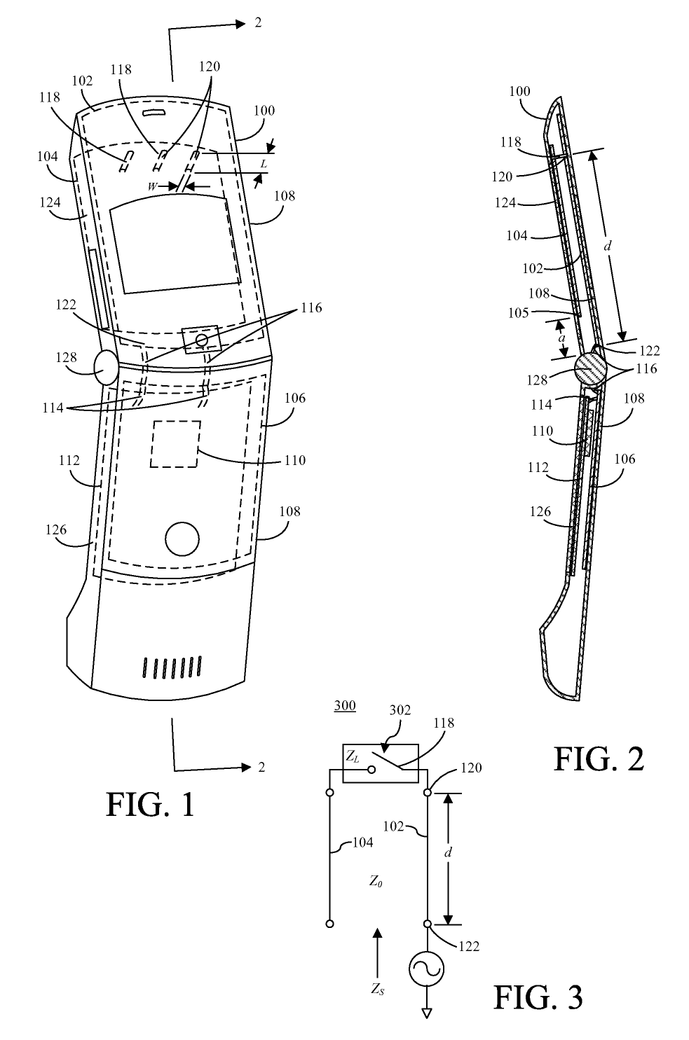

FIG. 1 depicts a wireless communication device (hereinafter “device”) 100 that is useful for understanding the present invention. FIG. 2 depicts a section view of the device 100 of FIG. 1, taken along section line 2-2. The device 100 can be a mobile station, for example a mobile telephone, a mobile radio, a personal digital assistant, a mobile computer or a portable gaming device. The mobile station also can be any other electronic device which may transmit and/or receive RF energy.

Referring both to FIG. 1 and FIG. 2, the device 100 can include a plurality of electrically conductive structural members (hereinafter “structural members”) which may serve as propagate and receive electromagnetic waves. For example, the wireless communication device can include a first structural member 102, a second structural member 104 and a third structural member 106. Each of the structural members 102, 104, 106 can comprise an electrically conductive material, for example a metal, an alloy, or any other suitable conductive material. As such, the structural members 102, 104, 106 can be rigid or semi-rigid. Thus, in addition to communicating RF energy, the structural members 102, 104, 106 can serve to protect components within the device 100 from damage due to impact.

The structural members 102, 104, 106 can be substantially planar or can be formed to have other shapes. For instance, the structural members 102, 104, 106 can be formed to comprise one or more curved and/or planar surfaces. In one arrangement, the structural members 102, 104, 106 each can form a significant portion of the device's shell. For example, one or more of the structural members 102, 104, 106 form one or more outer surfaces of the device 100. In such an arrangement, a dielectric coating can be applied to the structural members 102, 104, 106. Optionally, one or more dielectric covers 108 can be positioned over the structural members 102, 104, 106. The dielectric covers 108 can comprise, for instance, plastic. In one arrangement, a distance a can be provided between an end 105 of the second structural member 104 so as to prevent the end 105 from contacting other electrically conductive components. In another arrangement, the end 105 can be terminated to a chassis ground of the device 100.

The device 100 also can include a transceiver 110, which may be attached to a circuit board 112. The transceiver can communicate RF signals to and from one or more of the structural members 102, 104, 106, for instance via electrical conductors 114 which extend from the circuit board 112 to one or more of the structural members 102, 104, 106. Optionally, one or more electrical conductors 116 can provide electrical conductivity between the third structural member 106 and the first structural member 102. Accordingly, RF signals communicated to the third structural member 106 also can be communicated to the first structural member 102 via the electrical conductors 116, though this does not need to be the case. For instance, in lieu of the electrical conductors 116, RF energy can electromagnetically couple to the first structural member 102 from other components of the device 100, for instance from the third structural member 106.

One or more electrical conductors 118 can electrically connect a first portion 120 of the first structural member 102 to the second conductive structural member 104. The electrical conductor(s) 118 can be planar, cylindrical or any other desired shape. A distance d of the first portion 120 from a second portion 122 of the first structural member 102 can be selected to present a desired input impedance for RF signals applied at the second portion 122 of the first structural member 102.

For example, the distance d can be approximately one-quarter of a wavelength of an RF signal applied to the second portion 122, or an odd multiple of the one-quarter wavelength. In this arrangement, the first structural member 102 and the second structural member 104 together can act as a quarter-wavelength transmission line. FIG. 3 depicts an electrical schematic of such a transmission line 300.

Referring to FIGS. 1-3, when the distance d is one-quarter wavelength or an odd multiple of the one-quarter wavelength, the input, load and characteristic impedances can be related by the following equation:

Z_{S}=Z₀²/Z_{L} (1)

where, Z_{S} is the input impedance at the second portion 122 of the first structural member 102, Z₀ is the characteristic impedance of the transmission line structure formed by the first structural member 102 and the second structural member 104, and Z_{L} is the load impedance at a first portion 120 of the first structural member 102. Because the first portion 120 of the first structural member 102 is electrically connected to the second structural member 104, the load impedance can be very low.

The net load impedance Z_{L} can be determined, at least in part, by the dimensions of electrical conductor(s) 118. For example, the electrical conductors 118 can be selected to have a particular ratio of width W to length L, which inversely correlates to their inductive reactance. Further, the net inductive reactance at the load also inversely correlates to the number of electrical conductors 118 that are used to electrically connect the first structural member 102 to the second structural member 104. Thus, the dimensions (W, L) and the number of electrical conductors 118 that are used to connect the first structural member 102 to the second structural member 104 can be selected to achieve a desired load impedance Z_{L}. In an arrangement in which the electrical conductors 118 are cylindrical, a diameter of the electrical conductors 118 can be selected in lieu of width.

The characteristic impedance Z₀ of the first structural member 102 can be represented by the following equation:

$${Z}_{0} = \sqrt{\frac{j wL + R}{j wC + G}} \qquad ( 2 )$$

where, L is the inductance per unit length, C is the capacitance per unit length (e.g between the first structural member 102 and the second structural member 104), R is the resistance per unit length, and G is the conductance per unit length (e.g between the first structural member 102 and the second structural member 104). Assuming a lossless transmission line, equation (2) reduces to:

$${Z}_{0} = \sqrt{\frac{L}{C}} \qquad ( 3 )$$

The inductance L of the first and second structural members 102, 104 can be determined, at least in part, by their dimensions and the permeability of surrounding materials. The capacitance C can be determined, at least in part, by such dimensions, the distance between the structural members 102, 104, and the permittivity of materials positioned between the structural members 102, 104. The presence of other components can affect the values of inductance L and capacitance C, and thus the characteristic impedance Z₀. Nonetheless, the influence of such components on the characteristic impedance Z₀ may be modeled using techniques, such as finite element analysis, which are known to the skilled artisan.

Referring to equation (1), the use of a high characteristic impedance Z₀ and/or a low load impedance Z_{L} can result in a high input impedance Zₛ to the transmission line formed by the first and second structural members 102, 104. Such input impedance Zₛ can be presented to the RF signals applied to the second portion 122 of the first structural member 102. Due to the high input impedance Zₛ, the amount of signal energy communicated to the space inside the transmission line formed by the first structural member 102 and second structural member 104 can be relatively low with respect to the amount of signal energy communicated to the third structural member 106 or the space outside the structural member 102. By directing a greater portion of the RF signal energy to the third structural member 106 in this manner, in comparison to an arrangement in which both the first and third structural members 102, 106 receive an equal amount of RF energy, less of the RF signal energy will be disrupted during propagation due to the first portion 124 of the device 100 being held close to an external object (e.g. next to a user's head) during RF signal transmission. Moreover, less of the RF signal energy transmitted by the first portion 124 will be absorbed by such object.

In another arrangement, the distance d can be approximately one-half of a wavelength, or a multiple of the one-half wavelength, of an RF signal applied to the second portion 122. In this case the input impedance Zₛ of the transmission line formed by the first and second structural members 102, 104 can be approximately equal to the load impedance Z_{L} which, as noted, can be very low.

Due to the low input impedance Z_{L}, the amount of signal energy communicated to the first structural member 102 can be relatively high with respect to the amount of signal energy communicated to the third structural member 106. In comparison to an arrangement in which both the first and third structural members 102, 106 receive an equal amount of RF energy, less of the RF signal energy will be disrupted during propagation due to a second portion 126 of the device 100 (which comprises the third structural member 106) being held close to an external object during RF signal transmission. Moreover, less of the RF signal energy transmitted by the second portion 126 will be absorbed by such object. Such an arrangement can be beneficial if the second portion 126 of the device 100 is being held close to an external object during RF signal transmission while the first structural member 102 is more distant from the external object.

In yet another arrangement, the distance d can be selected to be any other desired fraction of a wavelength of the RF signal. Moreover, the distance d can be adjusted to achieve a desired input impedance Zₛ for the transmission line formed by the first and second structural members 102, 104. Once the characteristic impedance Z₀ and load impedance Z_{L} are determined, the input impedance Zₛ can be computed using known tools, such as a Smith Chart.

Referring to FIG. 3, in one aspect of the inventive arrangements, the conductor(s) 118 can be embodied as one or more switches 302. A switch 302 can be an electrical switch or an electromechanical switch and can comprise, for example, one or more pin diodes, one or more relays, or any other components suitable for selectively connecting and disconnecting the first structural member 102 to the second structural member 104. The switch 302 can be controlled by a controller, a processor, or any other suitable electronic components within the device 100. In an arrangement in which the switch 302 is an electrical switch, the switch 302 need not include components that physically move.

The switch 302 can be opened to disconnect the first structural member 102 from the second structural member 104, or closed to connect the first structural member 102 to the second structural member 104. In the context of the switch 302, to be “open” means to have a very high resistance, for example in excess of 1 MΩ, and to be “closed” means to have a low resistance, for example less than 100Ω. Opening or closing the switch 302 can change the load impedance at the first portion 120 of the first structural member 102, thereby changing the input impedance Zₛ at the second portion 122 of the first structural member 102, allowing the device 100 to be adapted to different usage conditions.

Referring to FIGS. 1 and 2, the first and second structural members 102, 104 can be rotatably linked to the third structural members 106. As used herein, the term “rotatably linked” means that, once assembled, the first and/or second structural members 102, 104 may rotate about an axis through which they are mechanically linked to the third structural members 106. For example, a first portion 124 of the device 100, which comprises the first and second structural members 102, 104, and/or a second portion 126 of the device 100, which comprises the third structural member 106, can be attached such that they rotate about a pivot member 128. The pivot member 128 can comprise a pin, a shaft, a fastener, or any other suitable device components. In such an arrangement, the electrical conductors 116 can be flexible.

In another arrangement, the structural members 102 and 104 and the associated conductor(s) 118 can be duplicated in the second portion 126 of the device 100 in lieu of the third structural member 106. Accordingly, the impedance, and thus the amount of signal energy, communicated to the second portion 126 also can be selectively controlled.

Examples of wireless communication devices with which the present invention can be incorporated are disclosed in U.S. patent application Ser. No. 11/314215, Navsariwala et al., filed Dec. 21, 2005, which is herein incorporated by reference in its entirety. In the case of conflict, the present specification, including definitions, will control.

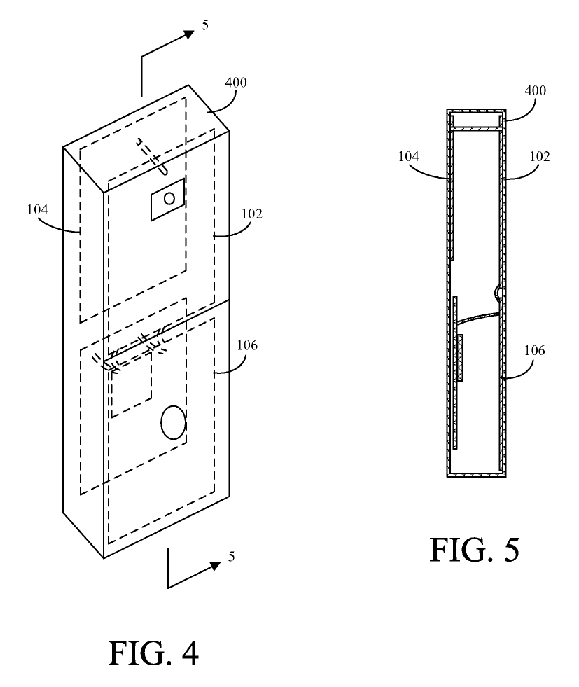

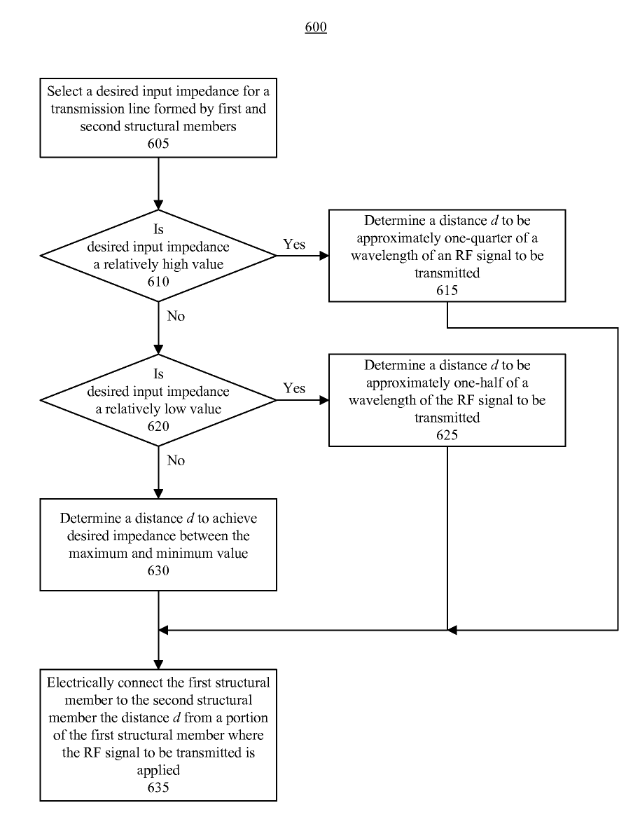

FIG. 4 depicts another example of a device 400 that is useful for understanding the present invention. FIG. 5 depicts a section view of the device 400 of FIG. 4, taken along section line 5-5. In contrast to the first example of the device 100 previously described, in the example 400 the first and second structural members 102, 104 may not be rotatably linked to the third structural member 106, although the first and second structural members 102, 104 still may be statically positioned with respect to the third structural member 106. As used herein, the term “statically positioned” means that, once assembled, the first, second and third structural members 102, 104, 106 generally do not move relative to one another.

The third structural member 106 can be directly attached to the first structural member 102 and/or the second structural member 104, or attached to one or more components (e.g. a shell) that statically positions the structural members 102, 104, 106 with respect to one another, regardless of whether they physically contact each other. In such an arrangement, the third structural member 106 can be co-planarly aligned with the first structural member 102 and/or co-planarly aligned with the second structural member 104, though this is not necessary.

FIG. 6 is a flow chart presenting a method 600 for improving communication efficiency of a wireless communication device. Beginning at step 605, a desired input impedance can be selected for a transmission line formed by the first and second structural members. At decision box 610, if the desired input impedance is a relatively high or maximum value, at step 615 a distance d can be determined to be approximately one-quarter of a wavelength of an RF signal to be transmitted (or an odd multiple of the one-quarter wavelength). Referring to decision box 620, if the desired impedance is a relatively low or minimum value, at step 625 a distance d can be determined to be approximately one-half of a wavelength of an RF signal to be transmitted (or a multiple of the one-half wavelength).

If the desired input impedance is not a low, minimum, high or maximum value, at step 630 the distance d can be determined to achieve a desired impedance between the maximum and minimum value, or the high and low value. Proceeding to step 635, the first structural member can be electrically connected to the second structural member at the distance d. The distance d can be measured from a portion of the first structural member where the RF signal to be transmitted is applied.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

This invention can be embodied in other forms without departing from the spirit or essential attributes thereof. Accordingly, reference should be made to the following claims, rather than to the foregoing specification, as indicating the scope of the invention.

What is claimed is:

1. A wireless communication device, comprising:
a first electrically conductive structural member;
a second electrically conductive structural member;
at least a first electrical conductor that electrically connects a first portion of the first structural member to the second structural member;
wherein a distance between the first portion and a second portion of the first structural member is selected to present a desired input impedance for an RF signal applied at the second portion of the first structural member.

2. The wireless communication device of claim 1, wherein the distance is approximately one-quarter of a wavelength of the RF signal or an odd multiple of the one-quarter wavelength.

3. The wireless communication device of claim 1, wherein the distance is approximately one-half of a wavelength of the RF signal or a multiple of the one-half wavelength.

4. The wireless communication device of claim 1, further comprising a third electrically conductive structural member.

5. The wireless communication device of claim 4, wherein the third structural member is a radiating member.

6. The wireless communication device of claim 4, wherein the first structural member is rotatably linked to the third structural member.

7. The wireless communication device of claim 4, wherein the first structural member is statically positioned with respect to the third structural member.

8. The wireless communication device of claim 4, further comprising at least a second electrical conductor that provides electrical conductivity between the third structural member and the first structural member.

9. The wireless communication device of claim 1, wherein dimensions of the first electrical conductor are selected to achieve a desired load impedance.

10. The wireless communication device of claim 1, wherein the first electrical conductor is embodied as an electronic or electromechanical switch.

11. The wireless communication device of claim 1, wherein the wireless communication device is a mobile telephone.

12. A wireless communication device, comprising:
a first electrically conductive structural member;
a second electrically conductive structural member;
at least one electrical conductor that electrically connects a first portion of the first structural member to the second structural member;
wherein a distance between the first portion and a second portion of the first structural member where an RF signal is applied is selected to be approximately one-quarter of a wavelength of the RF signal.

13. The wireless communication device of claim 12, further comprising a third electrically conductive structural member.

14. The wireless communication device of claim 12, wherein the third structural member is rotatably linked to the first structural member.

15. The wireless communication device of claim 12, wherein the third structural member is statically positioned with respect to the first structural member.

16. A method, comprising:
selecting a desired input impedance for a transmission line formed by a first electrically conductive structural member and a second electrically conductive structural member of a wireless communication device; and
electrically connecting a first portion of the first structural member to the second structural member at a selected distance from a second portion of the first structural member where an RF signal to be transmitted is applied, the distance selected to present a desired input impedance for the RF signal.

17. The method of claim 16, wherein:
selecting the desired input impedance comprises selecting the input impedance to have a high value;
electrically connecting the first portion of the first structural member to the second structural member comprises selecting the distance to be approximately one-quarter of a wavelength of the RF signal.

18. The method of claim 16, wherein:
selecting the desired input impedance comprises selecting the input impedance to have a low value; and
electrically connecting the first portion of the first structural member to the second structural member comprises selecting the distance to be approximately one-half of a wavelength of the RF signal.

19. The method of claim 16, further comprising rotatably linking the third structural member to the first structural member.

20. The method of claim 16, further comprising statically positioning the third structural member with respect to the first structural member.
